(19) United States
(12) Patent Application Publication
(10) Pub. No.: US 2015/0217437 A1
(43) Pub. Date: Aug. 6, 2015

(54) Sod Staple Inserter

(71) Applicant: Mark Howard Thomaschefsky, Sterling, IL (US)

(72) Inventor: Mark Howard Thomaschefsky, Sterling, IL (US)

(21) Appl. No.: 14/172,903

(22) Filed: Feb. 5, 2014

(51) Int. Cl. B25C 5/11; A01G 13/00

(52) U.S. Cl. CPC B25C 5/11; A01G 13/0293

(57) ABSTRACT

Newly laid sod often requires extra support to stay in the correct spot to allow it to grow. The present invention relates to a device that allows for a more ergonomic and convenient way to securely drive sod or erosion control mat staples into the ground. The invention uses a handle connected to a driving rod. The driving rod is comprised of an elongated member that has a spring wrapped around it, with a spring restricting member on each end of the driving rod. These spring restricting members make sure the spring does not slip out of alignment when the spring is compressing or expanding. The driving rod is then securely attached to a driving plate. The driving plate and driving rod is what bears the force that is exerted on the handle and drives the pin into the ground. The entire structure is covered by a pair of protective members with a top end cap that prevents the users from getting their hand caught in the inner workings of the device, and an end cap that has an opening for inserting the pin.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not Applicable

### BACKGROUND OF THE INVENTION

1. Field of the Invention

Devices for securely attaching sod or erosion control mat pins into the ground currently exist. The existing devices do have drawbacks however. Many current devices allow for multiple pins to be loaded into the device that drives the pin into the ground. Allowing for multiple pins adds a degree of convenience, but at the cost of the device frequently jamming during the reloading process. The present invention addresses this by only allowing a single pin to be loaded at a time.

2. Description of Related Art

There is existing prior art that addresses devices for driving pins to secure erosion control devices.

U.S. Pat. No. 8,152,040 discloses a device that allows a user to drive pins into the ground using solely their hands, with no mechanism for adding additional force with their feet if required.

U.S. Pat. No. 6,585,456 discloses a device that allows a side loading mechanism for driving pins into the ground.

### BRIEF SUMMARY OF THE INVENTION

The present invention relates to a device that allows for a more ergonomic and convenient way to securely drive sod or erosion control mat pins into the ground. The invention uses a handle connected to a driving rod. The driving rod is comprised of an elongated member that has a spring wrapped around it, with a spring restricting member on each end of the driving rod. These spring restricting members make sure the spring does not slip out of alignment when the spring is compressing or expanding. The driving rod is then securely attached to a driving plate. The driving plate and driving rod is what bears the force that is exerted on the handle and drives the pin into the ground. The entire structure is covered by a pair of protective members with a top end cap that prevents the users from getting their hand caught in the inner workings of the device, and an end cap that has an opening for inserting the pin.

### BRIEF DESCRIPTION OF THE SEVERAL VIEWS OF THE DRAWINGS

The invention may take form in certain components and structures, preferred embodiments of which are illustrated in the accompanying drawings which form a part hereof and wherein:

FIG. 1A is a perspective view of the device for driving pins into the ground.

FIG. 1B is a perspective view of the device showing the inner structure of the device.

FIG. 1C is a side view of the device showing the inner structure of the device.

FIG. 2A is a perspective view of the spring restrictor.

FIG. 2B is a top down view of the spring restrictor.

FIG. 3A is a perspective view of the top end cap.

FIG. 3B is a top view of the top end cap.

FIG. 4A is a top down view of the bottom end cap.

FIG. 4B is a perspective view of the bottom end cap.

FIG. 5A is a perspective view of the first half of the staple holder.

FIG. 5B is a perspective view of the second half of the staple holder.

FIG. 5C is a perspective view of the both halves of the staple holder connected together.

FIG. 5D is a top down view of one half of the staple holder.

FIG. 6 is a perspective view of the second protective member.

FIG. 7 is a perspective view of the first protective member.

FIG. 8 is a perspective view of the driving plate.

FIG. 9 is a side view of the driving rod and driving plate without the outer casing.

FIG. 10 is a side view of the spring.

FIG. 11 is a side view of the hair pin.

FIG. 12 is a perspective view of the washer.

FIG. 13 is a perspective view of the roll pin.

### DETAILED DESCRIPTION OF THE INVENTION

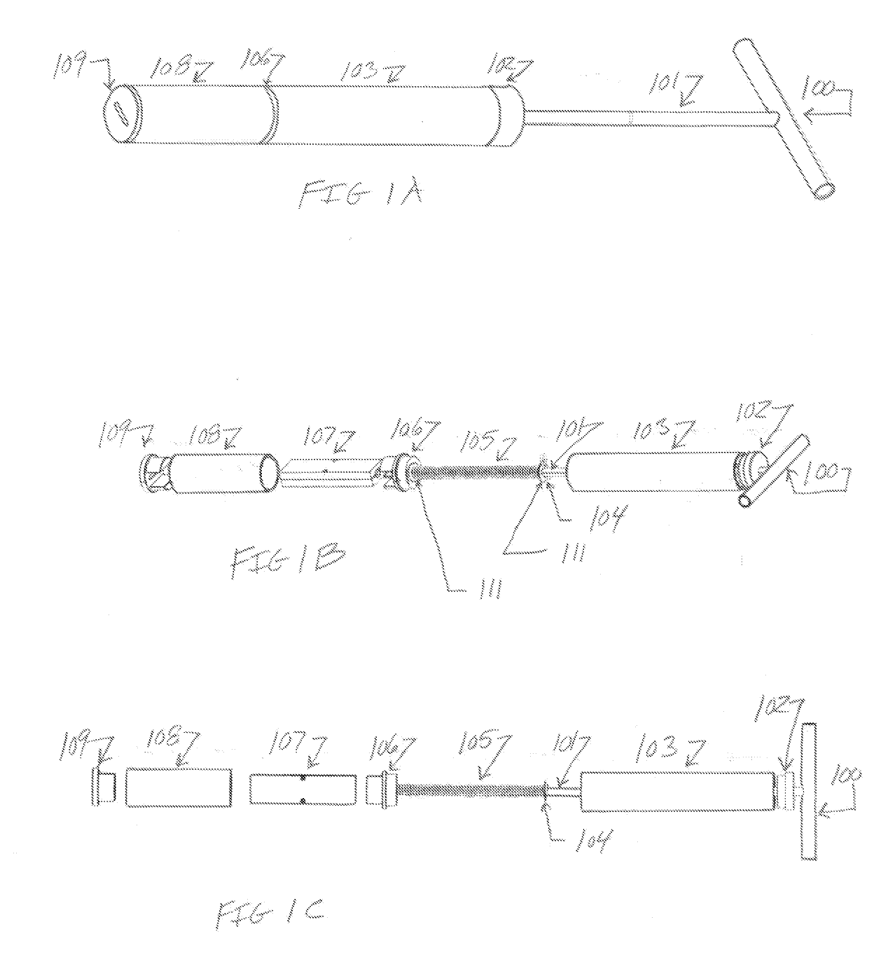

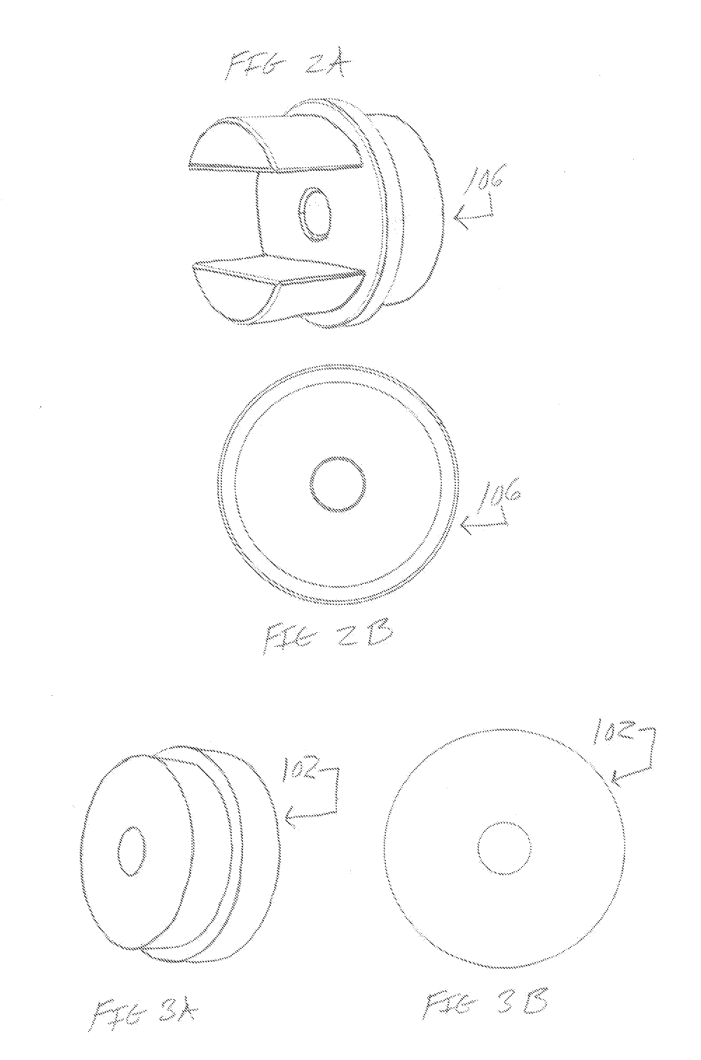

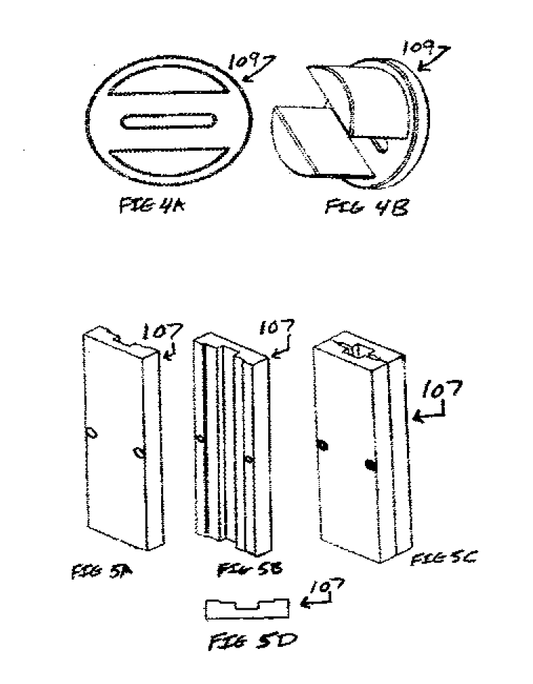

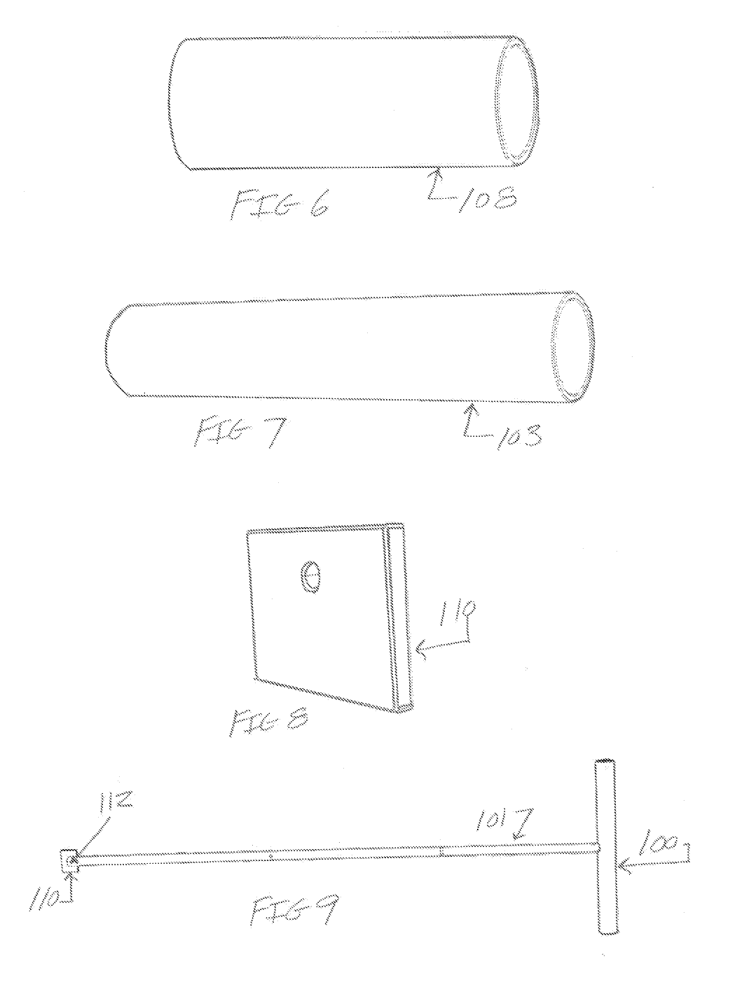

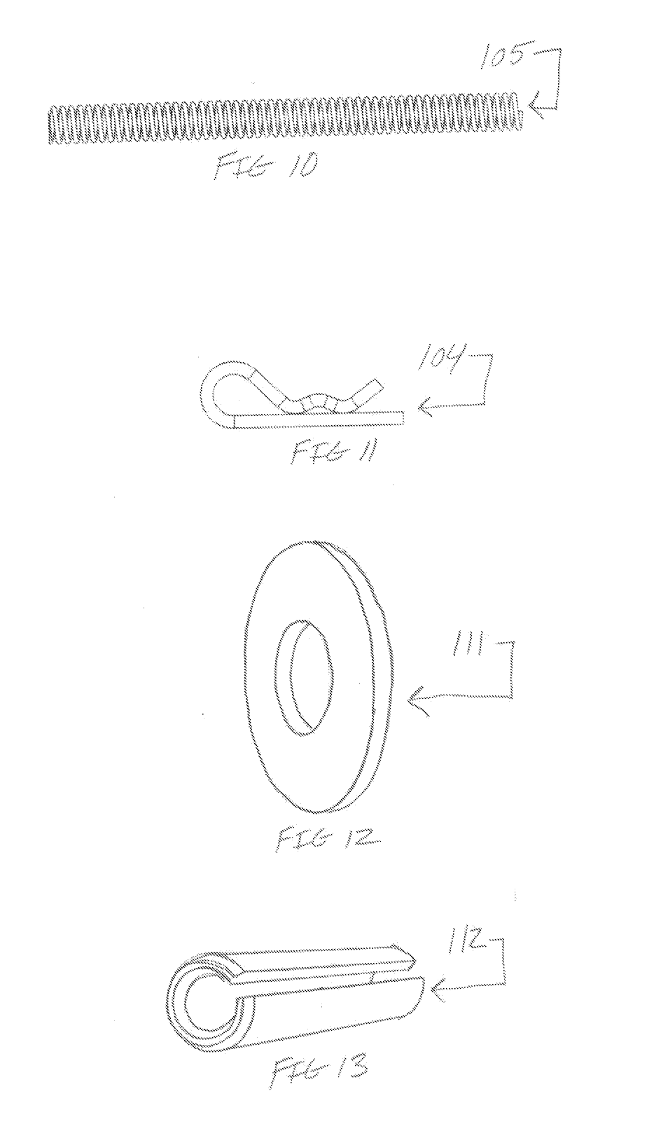

The invention is carried out as illustrated in FIGS. 1-13. A handle 100 is securely connected to a first end of a driving rod 101. The handle 100 can be made of any strong and durable material. Preferably, the handle 100 is made of aluminum or some form of steel. The handle 100 can be any shape that allows a user to get a secure grip on the handle and a common shape for this purpose is a cylindrical shape. The driving rod 101 needs to be made of any strong and durable material. The driving rod 101 is preferably made of aluminum or some form of steel. A cylinder is the preferable shape for the driving rod 101.

The top end cap 102 can be made of any sturdy, yet somewhat flexible material. Plastic would work for the material for the top end cap 102. An injection molded plastic is preferable for cost purposes. The top end cap 102 is used to prevent the user from getting their hand caught in the inner workings of the device and also to lock a hollow first protective member in place 103. The top end cap 102 has a top half and a bottom half where each half has the shame shape. The bottom half is thinner than the top half so there is a gap between the edge around the perimeter of the bottom half compared to the edge around the perimeter of the top half. This gap in the top end cap 102 will allow the first protective member 103 to engage and lock in place around the bottom half of the top end cap 102. The preferred shape for the top half and the bottom half of the top end cap 102 is a cylinder. Within the top end cap 102, there is a hollow center that allows the driving rod 101 to slide through the top end cap 102.

The first protective member 103 has a top end and a bottom end and the top end of the first protective member is what connects to the top end cap 102 to lock both of them in place. The first protective member 103 can be any shape so long as it will securely encase the driving rod 101. As the preferred shape for the driving rod 101 is a cylinder, the preferred shape of the first protective member 103 is also a cylinder. The first protective member 103 needs to be made of a sturdy material. Any sturdy plastic will work for the first protective member 103. PVC plastic is one commonly known plastic that would work.

A first spring restrictor 104 is used to keep a top end of a spring 105 in the proper position. The spring is wrapped around the driving rod 101. The spring 105 can be made of any material, so long as the material allows the spring to maintain the unique properties of a spring. Metal is the preferable material for the spring 105.

The first spring restrictor 104 can be made of any sturdy yet flexible material that can securely hold the spring 105 in place and fit within the first protective member 103. For cost purposes, the preferable material for the first spring restrictor 104 is a washer 111 and a hair pin clip 104. The hair pin clip 104 clips against the spring 105 with the washer 111 in between to distribute the load. A standard hair pin clip 104 will work sufficiently for holding the spring 105 in place.

The second spring restrictor 106 has a similar design to the top end cap 102 although inverted. The second spring restrictor 106 has the same gap between the halves and a hollow center that allows the driving rod 101 to slide through the second spring restrictor 106. The second spring restrictor 106 is “inverted” from the top end cap 102 as the top half is the thinner half. In addition, on the bottom side of the bottom half of the second spring restrictor 106 has two securing prongs. The second spring restrictor 106 is also preferably made of plastic, and most preferably made of an injection molded plastic for cost purposes.

The two securing prongs on the bottom of the second spring restrictor 106 and two securing prongs on the top of the bottom end cap 109 are used to hold the staple holder 107 in place. The staple holder 107 has to be made of a sturdy material. The staple holder 107 can be any shape that will hold the pin while allowing the driving member 101 to drive a pin into the ground. A rectangular shape is the preferable shape for the staple holder 107 as this provides the most stability to the device while holding the pin and allowing the driving member 101 to drive a pin into the ground. Plastic is the preferred material for the staple holder 107 and injection molded plastic is most preferred for cost purposes. The driving plate 110 is connected to the driving rod 101 by a roll pin 112. The driving plate 110 actually makes direct contact with the pin when driving it into the ground. Due to the driving plate 110 actually making direct contact with the pin, it needs to be made of a very durable material. Steel is one material that would work for the driving plate 110.

The second protective member 108 is similar to the first protective member 103 with a hollow center and a top end and bottom end. The second protective member 108 also needs to be made of a sturdy material. Similar to the first protective member 103, any sturdy plastic will work for the second protective member 108. PVC plastic is one commonly known plastic that would work. A cylinder is also the preferable shape for the second protective member 108.

The bottom end of the second protective member 108 is secured by a bottom end cap 109. The bottom end cap 109 has the same two pronged design that the second spring restrictor 106 has, though the two prongs are on the top side of the end cap 109. The two prongs serve the same purpose as they hold the staple holder 107 in place from the opposite end as the second spring restrictor 106. The bottom end cap 109 needs to be the same shape as the second protective member 108 so that it will provide and lock into place on the bottom end of the second protective member 108. The preferred shape for the second protective member 108 is a cylinder, so the preferred shape for the bottom end cap 109 is also cylindrical.

There is a slot in the center of the bottom end cap 109 that allows a pin to fit into the device so that when someone pushes down on the handle 100, the driving member will push down onto the pin and push the pin securely into the ground. When the device is fully assembled, it will look smooth all the way around from the outside. The handle 100, a small portion of the driving rod 101, a part of the top end cap 102, the first protective member 103, and a small portion of the second spring restrictor 106, the second protective member 108, and the end cap 109 with the slot for the pin will be all that is visible. Plastic is the preferred material for the bottom end cap 109 and injection molded plastic is most preferred for cost purposes.

1. A device for driving pins into new sod or erosion control mat to attach it to the ground, comprising:
a handle comprised of a sturdy material and in a grip enhancing shape;
a driving member comprised of a sturdy material and is in a secure driving shape that allows sufficient force to be applied to drive a staple into the ground;
wherein said driving member has a top end, a middle section and a bottom end;
a top end cap with a hollow center and an encasing shape;
wherein said top end cap is made of a sturdy yet somewhat flexible material;
wherein said top end cap comprises a top half and a bottom half where each half has a shame shape;
wherein said bottom half of said top end cap is thinner than sand top half so there is a gap between the edge around the perimeter of said bottom half compared to the edge around the perimeter of said top half;
wherein said driving member is run through said hollow center of said top end cap;
a first protective member comprised of a sturdy material and in a protective shape;
and wherein said first protective member has a top end and a bottom end;
wherein said protective shape of said first protective member is complementary to said same shape of said bottom half of said top end cap to allow said first protective member to lock tightly around said bottom half of said top end cap;
a second protective member comprised of a sturdy material and in a protective shape and wherein said second protective member has a top end and a bottom end;
a first spring restricting member and a second spring restricting member;
wherein said second spring restricting member has a top end and a bottom end;
a spring of a shape that securely fits around said secure driving shape;
wherein said spring has a top end and a bottom end;
wherein said top end of said spring is held in place by first spring restricting member;
wherein said spring wraps around said middle section of said driving member;
wherein said top end of said second spring restricting member has an inner top end shape and an outer top end shape;
wherein said inner top end shape of said secondary spring restricting member is complementary to said secure driving shape of said driving member that allows said top end of said second spring restricting member and said secure driving shape of said bottom end of said driving member to fit snugly together;
wherein said outer top end shape of said secondary spring restricting member is complementary to said protective shape of said second protective member to allow said outer top end shape of said secondary spring restricting member and said protective shape of said second protective member to lock together into place;
wherein said bottom end of said second spring restricting member has a bottom has a securing protrusion;
a driving plate that is securely connected to said driving member so that force can be exerted on said driving member and said driving plate will come into direct contact with said staple and will not dislodge;
a staple holder with a top end and a bottom end;
wherein said securing protrusion of said second spring restricting member securely holds said staple holder;
wherein said staple holder is comprised of a shape that will allow for a staple to be securely held within said staple holder while force is being exerted downwards onto it;
wherein said bottom end of said second protective member is complementary to an end cap;
wherein said end cap has a top end and a bottom end;
wherein said top end of said end cap has a protrusion that securely holds said bottom end of said staple holder;
wherein said end cap is of a shape that allows it to fit snugly into said bottom end of said second protective member with a hollow space within said end cap that allows a staple to fit through said hollow space so that said driving member can exert sufficient force to drive said staple into the ground.

2. The device of claim 1, wherein said sturdy material of said handle is comprised of aluminum or some form of steel.

3. The device of claim 2, wherein said sturdy material of said driving member, said driving plate and said spring is comprised of steel.

4. The device of claim 3 wherein said grip enhancing shape of said handle is a cylindrical shape.

5. The device of claim 4, wherein said sturdy material of said top end cap, said bottom end cap, said second spring restrictor, said staple holder, said first protective member and said second protective member is comprised of plastic.

6. The device of claim 4, wherein said sturdy material of said top end cap, said bottom end cap, said second spring restricting member and said staple holder is made of injection molded plastic.

7. The device of claim 4, wherein said protective shape of said protective member is comprised of a pair of interconnected cylinders made of hard plastic.

8. The device of claim 6, wherein said secure driving shape of said driving member is a cylinder.

9. The device of claim 7, wherein said secure driving shape of said driving member is a cylinder.

10. The device of claim 9, wherein said shape of said staple holder is rectangular.

11. A device for driving pins into new sod or erosion control mat to attach it to the ground, comprising:
a handle comprised of a sturdy material and in a cylindrical shape;
a driving member comprised of a sturdy material and is in a cylindrical shape that allows sufficient force to be applied to drive a staple into the ground;
wherein said driving member has a top end, a middle section and a bottom end;
a top end cap with a hollow center and a cylindrical shape;
wherein said top end cap is made of a sturdy yet somewhat flexible material;
wherein said top end cap comprises a top half and a bottom half where each half has a same cylindrical shape;
wherein said bottom half of said top end cap is thinner than sand top half so there is a gap between the edge around the perimeter of said bottom half compared to the edge around the perimeter of said top half;
wherein said driving member is run through said hollow center of said top end cap;
a first protective member comprised of a sturdy material and in a cylindrical shape;
and wherein said first protective member has a top end and a bottom end;
wherein said protective shape of said first protective member is complementary to said same shape of said bottom half of said top end cap to allow said first protective member to lock tightly around said bottom half of said top end cap;
a second protective member comprised of a sturdy material and in a cylindrical shape and wherein said second protective member has a top end and a bottom end;
a first spring restricting member and a second spring restricting member;
wherein said second spring restricting member has a top end and a bottom end;
a spring of a shape that securely fits around said cylindrical shape of said driving member;
wherein said spring has a top end and a bottom end;
wherein said top end of said spring is held in place by first spring restricting member;
wherein said spring wraps around said middle section of said driving member;
wherein said top end of said second spring restricting member has an inner top end shape and an outer top end shape;
wherein said inner top end shape of said secondary spring restricting member is complementary to said cylindrical shape of said driving member that allows said top end of said second spring restricting member and said secure driving shape of said bottom end of said driving member to fit snugly together;
wherein said outer top end shape of said secondary spring restricting member is complementary to said protective shape of said second protective member to allow said outer top end shape of said secondary spring restricting member and said protective shape of said second protective member to lock together into place;
wherein said bottom end of said second spring restricting member has a bottom has a securing protrusion;
a driving plate that is securely connected to said driving member so that force can be exerted on said driving member and said driving plate will come into direct contact with said staple and will not dislodge;
a staple holder with a top end and a bottom end;
wherein said securing protrusion of said second spring restricting member securely holds said staple holder;
wherein said staple holder is comprised of a shape that will allow for a staple to be securely held within said staple holder while force is being exerted downwards onto it;
wherein said bottom end of said second protective member is complementary to an end cap;
wherein said end cap has a top end and a bottom end;
wherein said top end of said end cap has a protrusion that securely holds said bottom end of said staple holder;
wherein said end cap is of a shape that allows it to fit snugly into said bottom end of said second protective member with a hollow space within said end cap that allows a staple to fit through said hollow space so that said driving member can exert sufficient force to drive said staple into the ground.

12. The device of claim 11, wherein said sturdy material of said handle is comprised of aluminum or some form of steel.

13. The device of claim 12, wherein said sturdy material of said driving member, said driving plate and said spring is comprised of steel.

14. The device of claim 13, wherein said sturdy material of said top end cap, said bottom end cap, said second spring restrictor, said staple holder, said first protective member and said second protective member is comprised of plastic.

15. The device of claim 14, wherein said sturdy material of said top end cap, said bottom end cap, said second spring restricting member and said staple holder is made of injection molded plastic.

16. A device for driving pins into new sod or erosion control mat to attach it to the ground, comprising:
a handle comprised of a sturdy material and in a rectangular shape;
a driving member comprised of a sturdy material and is in a rectangular shape that allows sufficient force to be applied to drive a staple into the ground;
wherein said driving member has a top end, a middle section and a bottom end;
a top end cap with a hollow center and a rectangular shape;
wherein said top end cap is made of a sturdy yet somewhat flexible material;
wherein said top end cap comprises a top half and a bottom half where each half has a same rectangular shape;
wherein said bottom half of said top end cap is thinner than sand top half so there is a gap between the edge around the perimeter of said bottom half compared to the edge around the perimeter of said top half;
wherein said driving member is run through said hollow center of said top end cap;
a first protective member comprised of a sturdy material and in a rectangular shape;
and wherein said first protective member has a top end and a bottom end;
wherein said protective shape of said first protective member is complementary to said same shape of said bottom half of said top end cap to allow said first protective member to lock tightly around said bottom half of said top end cap;
a second protective member comprised of a sturdy material and in a rectangular shape and wherein said second protective member has a top end and a bottom end;
a first spring restricting member and a second spring restricting member;
wherein said second spring restricting member has a top end and a bottom end;
a spring of a shape that securely fits around said secure driving shape;
wherein said spring has a top end and a bottom end;
wherein said top end of said spring is held in place by first spring restricting member;
wherein said spring wraps around said middle section of said driving member;
wherein said top end of said second spring restricting member has an inner top end shape and an outer top end shape;
wherein said inner top end shape of said secondary spring restricting member is complementary to said secure driving shape of said driving member that allows said top end of said second spring restricting member and said rectangular shape of said bottom end of said driving member to fit snugly together;
wherein said outer top end shape of said secondary spring restricting member is complementary to said rectangular shape of said second protective member to allow said outer top end shape of said secondary spring restricting member and said rectangular shape of said second protective member to lock together into place;
wherein said bottom end of said second spring restricting member has a securing protrusion;
a driving plate that is securely connected to said driving member so that force can be exerted on said driving member and said driving plate will come into direct contact with said staple and will not dislodge;
a staple holder with a top end and a bottom end;
wherein said securing protrusion of said second spring restricting member securely holds said staple holder;
wherein said staple holder is comprised of a rectangular shape that will allow for a staple to be securely held within said staple holder while force is being exerted downwards onto it;
wherein said bottom end of said second protective member is complementary to an end cap;
wherein said end cap has a top end and a bottom end;
wherein said top end of said end cap has a protrusion that securely holds said bottom end of said staple holder;
wherein said end cap is of a shape that allows it to fit snugly into said bottom end of said second protective member with a hollow space within said end cap that allows a staple to fit through said hollow space so that said driving member can exert sufficient force to drive said staple into the ground.

17. The device of claim 16, wherein said sturdy material of said handle is comprised of aluminum or some form of steel.

18. The device of claim 17, wherein said sturdy material of said driving member, said driving plate and said spring is comprised of steel.

19. The device of claim 18, wherein said sturdy material of said top end cap, said bottom end cap, said second spring restrictor, said staple holder, said first protective member and said second protective member is comprised of plastic.

20. The device of claim 19, wherein said sturdy material of said top end cap, said bottom end cap, said second spring restricting member and said staple holder is made of injection molded plastic.
